(19) United States
(12) Patent Application Publication
(10) Pub. No.: US 2019/0346562 A1
(43) Pub. Date: Nov. 14, 2019

(54) SYSTEMS AND METHODS FOR RADAR CONTROL ON UNMANNED MOVABLE PLATFORMS

(71) Applicant: SZ DJI TECHNOLOGY CO., LTD., Shenzhen (CN)

(72) Inventors: Xueming PENG, Shenzhen (CN); Han HUANG, Shenzhen (CN); Xiaying ZOU, Shenzhen (CN); Qiang GU, Shenzhen (CN)

(21) Appl. No.: 16/519,803

(22) Filed: Jul. 23, 2019

Related U.S. Application Data
(63) Continuation of application No. PCT/CN2017/072449, filed on Jan. 24, 2017.

(51) Int. Cl. G01S 13/93; G01S 7/40; G01S 13/86; G05D 1/10

(52) U.S. Cl. CPC G01S 13/9303; G01S 7/4026; B64C 39/024; G05D 1/101; G01S 13/86

(57) ABSTRACT

An unmanned movable platform (UMP) includes at least one sensor configured to detect a movement associated with the UMP, at least one radar configured to transmit a radar signal, and at least one processor configured to receive a sensor signal associated with the movement from the at least one sensor and direct the at least one radar to adjust a direction of a beam of the radar signal based at least in part on the sensor signal.

### CROSS-REFERENCE TO RELATED APPLICATION

This application is a continuation of International Application No. PCT/CN2017/072449, filed on Jan. 24, 2017, the entire content of which is incorporated herein by reference.

### TECHNICAL FIELD

The present disclosure generally relates to systems and methods for radar control. Specifically, the present disclosure relates to an implementation on an unmanned movable platform for controlling direction of a radar beam.

### BACKGROUND

Unmanned movable platforms (UMP) such as unmanned aerial vehicles (UAV) have been widely used in various fields such as aerial photography, surveillance, scientific research, geological survey, and remote sensing. Such UAVs may include sensors and configured to collect data from the surrounding environment and may be programmed to understand the surrounding environment. During navigation, a UAVs may be manually controlled by a remote user. Alternatively, the UAV may operate in an autonomous mode.

To safely navigate under the autonomous mode, it is crucial for the UAV to recognize and avoid any obstacle in a navigation way. Further, the UAV should also be able to continue monitoring its surroundings to avoid any objects that the UAV might collide into during maneuver.

### SUMMARY

An aspect of the present disclosure is related to systems and methods for adaptively adjusting a direction of a radar beam on an unmanned movable platform, such as an unmanned aerial vehicle, so as to substantially keep the radar beam to a predetermined direction while the unmanned movable platform is maneuvering during navigation.

According to an aspect of the present disclosure, an unmanned movable platform (UMP) may include at least one sensor configured to detect an acceleration associated with the unmanned movable platform; at least one radar configured to transmit radar signal (Tx radar signal) towards a predetermined direction; and at least one processor. The at least one processor may be configured to: receive sensor signal reflecting the acceleration from the at least one sensor; and direct the at least one radar to adaptively adjust the radar signal to a direction according to the sensor signal.

According to another aspect of the present disclosure, a method for adjusting radar signal direction on an unmanned movable platform may include: transmitting radar signal (Tx radar signal) towards a predetermined direction; detecting an acceleration associated with an unmanned movable platform; and adaptively adjusting the radar signal to maintain the predetermined direction according to the acceleration.

### BRIEF DESCRIPTION OF THE DRAWINGS

The present disclosure is further described in terms of exemplary embodiments. The foregoing and other aspects of embodiments of present disclosure are made more evident in the following detail description, when read in conjunction with the attached drawing figures.

FIG. 1 illustrates an example unmanned aerial vehicle according to embodiments of the present disclosure;

FIG. 2 illustrates an example radar control system of the unmanned aerial vehicle according to embodiments of the present disclosure;

FIG. 3 illustrates the unmanned aerial vehicle equipped with a plurality of radars according to embodiments of the present disclosure;

FIGS. 4A-4G illustrate an unmanned aerial vehicle that transmits radar beams towards a predetermined directions under different flight attitudes, according to embodiments of the present disclosure;

FIG. 5 illustrates the unmanned aerial vehicle that maneuvers through an environment with obstacles, according to embodiments of the present disclosure;

FIG. 6 illustrates a method for an unmanned aerial vehicle to detect and avoid an obstacle during navigation, according to embodiments of the present disclosure; and

FIG. 7 is a block diagram of a processor of the unmanned aerial vehicle according to embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may or may not be implemented in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to unmanned moving platforms, it should also be understood that this is only one exemplary embodiment. The system or method of the present disclosure may be applied to any other kind of moving platforms.

The present disclosure provides systems and methods for radar control during a maneuver of an unmanned movable platform, such as when avoiding an obstacle object. An unmanned movable platform (UMP) may be an unmanned aerial vehicle (UAV) capable of aerial navigation. For example, the UAV may be a multiple rotary-wing craft, such as a quadcopter. The unmanned movable platform may also be an unmanned vehicle capable of navigating on or in other media, such as water or ground. For example, the unmanned movable platform may be an unmanned surface water ship, an unmanned submarine, or an unmanned ground vehicle. Further, the unmanned movable platform may be a vehicle that may navigate through more than one media. For example, the unmanned movable platform may be an unmanned hovercraft. The present disclosure intends to cover the broadest range of unmanned vehicle available and perceivable at the time of the filing of the present disclosure.

Purely for illustration purpose, the present disclosure uses an UAV (e.g., a quadcopter) as an example to demonstrate the systems and methods for controlling. The embodiments provided herein may be applied to various types of UAVs. For example, the UAV may be a small-scale UAV that weighs no more than 10 kg and/or has a maximum dimension of no more than 1.5 m. In some embodiments, the UAV may be a rotorcraft, such as a multi-rotor aircraft that is propelled to move through the air by a plurality of propellers (e.g., a quadcopter).

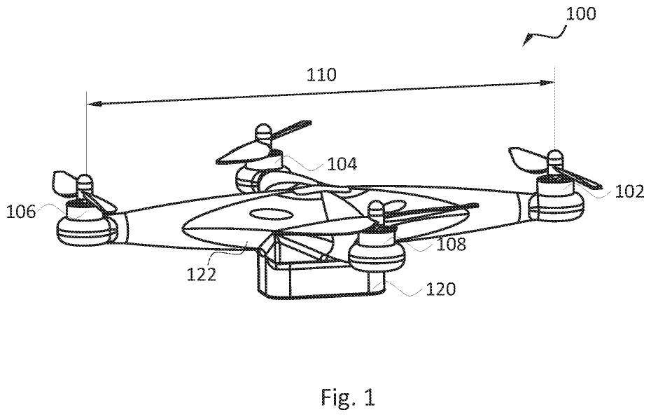

FIG. 1 illustrates a UAV 100 as an example of a unmanned movable platform described herein, in accordance with embodiments of the present disclosure. The UAV 100 may include a propulsion system having a plurality of rotors and Electronic Speed Control (ESC). For example, the UAV 100 in FIG. 1 includes four rotors 102, 104, 106, and 108. The rotors may be embodiments of the self-tightening rotors. The rotors, rotor assemblies, or other propulsion systems of the unmanned aerial vehicle may enable the unmanned aerial vehicle to hover/maintain position, change orientation, attitude, and/or change location in the air. The distance between shafts of opposite rotors may be any suitable length 110. For example, the length 110 may be less than or equal to 2 m, or less than equal to 5 m. In some embodiments, the length 110 may be within a range from 40 cm to 1 m, from 10 cm to 2 m, or from 5 cm to 5 m. Any description herein of a UAV may apply to a movable object, such as a movable object of a different type, and vice versa. The ESC may be connected and in communication with a processor of the UAV 100. The processor may direct the ESC to control rotation speed of the plurality of rotors.

In some embodiments, the UAV 100 may be configured to carry a load 120. The load 120 may include one or more of external equipment, passengers, cargo, equipment, instruments, and the like. The load may be provided within a housing. The housing may be separate from a housing 122 of the UAV, or be part of the housing 122 of the UAV. Alternatively, the load may be provided with a housing while the UAV does not have a housing. Alternatively, portions of the load 120 or the entire load 120 may be provided without a housing. The load may be rigidly fixed relative to the UAV 100. Alternatively, the load 120 may be movable relative to the UAV 100 (e.g., translatable or rotatable relative to the movable object).

In some embodiments, the UAV 100 may include a payload in the load 120 or in the housing 122. The payload (e.g., a passenger) may be configured not to perform any operation or function. Alternatively, the payload may be a payload configured to perform an operation or function, also known as a functional payload. For example, the payload may include one or more sensors for surveying one or more targets. Any suitable sensor may be incorporated into the payload, such as an image capture device (e.g., a camera), an audio capture device (e.g., a parabolic microphone), an infrared imaging device, or an ultraviolet imaging device. The sensor may provide static sensing data (e.g., a photograph) or dynamic sensing data (e.g., a video). In some embodiments, the sensor may provide sensing data for a target of the payload. Alternatively or in combination, the payload may include one or more emitters for providing signals to one or more targets. Any suitable emitter may be used, such as an illumination source or a sound source. In some embodiments, the payload may include one or more transceivers, such as for communication with a module remote from the UAV 100. The payload may also be configured to interact with the environment or a target. For example, the payload may include a tool, instrument, or mechanism capable of manipulating objects, such as a robotic arm.

The UAV 100 may include one or more sensors configured to collect relevant data, such as information relating to the UAV state, the surrounding environment, or the objects within the environment. Exemplary sensors suitable for use with the embodiments disclosed herein include location sensors (e.g., global positioning system (GPS) sensors, mobile device transmitters enabling location triangulation), vision sensors (e.g., imaging devices capable of detecting visible, infrared, or ultraviolet light, such as cameras), proximity or range sensors (e.g., ultrasonic sensors, LIDAR (Light Detection and Ranging), time-of-flight or depth cameras), inertial sensors (e.g., accelerometers, gyroscopes, inertial measurement units (IMUs)), altitude sensors, attitude sensors (e.g., compasses, IMUs) pressure sensors (e.g., barometers), audio sensors (e.g., microphones) or field sensors (e.g., magnetometers, electromagnetic sensors). Any suitable number and combination of sensors may be used, such as one, two, three, four, five, or more sensors. The data may be received from sensors of different types (e.g., two, three, four, five, or more types). Sensors of different types may measure different types of signals or information (e.g., position, orientation, velocity, acceleration, proximity, pressure, etc.) and/or utilize different types of measurement techniques to obtain data. For example, the sensors may include any suitable combination of active sensors (e.g., sensors that generate and measure energy from their own energy source) and passive sensors (e.g., sensors that detect available energy). As another example, some sensors may generate absolute measurement data that is provided in terms of a global coordinate system (e.g., position data provided by a GPS sensor, attitude data provided by a compass or magnetometer), while other sensors may generate relative measurement data that is provided in terms of a local coordinate system (e.g., relative angular velocity provided by a gyroscope; relative translational acceleration provided by an accelerometer; relative attitude information provided by a vision sensor; relative distance information provided by an ultrasonic sensor, LIDAR, or time-of-flight camera). In some instances, the local coordinate system may be a body coordinate system that is defined relative to the UAV.

The sensors may be configured to collect various types of data, such as data relating to the UAV 100, the surrounding environment, or objects within the environment. For example, at least some of the sensors may be configured to provide data regarding a state of the UAV 100. The state information provided by a sensor may include information regarding a spatial disposition of the UAV 100 (e.g., location or position information such as longitude, latitude, and/or altitude; orientation or attitude information such as roll, pitch, and/or yaw). The state information may also include information regarding motion of the UAV 100 (e.g., translational velocity, translation acceleration, angular velocity, angular acceleration, etc.). A sensor may be configured, for example, to determine a spatial disposition and/or motion of the UAV 100 with respect to up to six degrees of freedom (e.g., three degrees of freedom in position and/or translation, three degrees of freedom in orientation and/or rotation). The state information may be provided relative to a global coordinate system or relative to a local coordinate system (e.g., relative to the UAV or another entity). For example, a sensor may be configured to determine the distance between the UAV and the user controlling the UAV, or the distance between the UAV and the starting point of flight for the UAV.

The data obtained by the sensors may provide various types of environmental information. For example, the sensor data may be indicative of an environment type, such as an indoor environment, outdoor environment, low altitude environment, or high altitude environment. The sensor data may also provide information regarding current environmental conditions, including weather (e.g., clear, rainy, snowing), visibility conditions, wind speed, time of day, and so on. Furthermore, the environmental information collected by the sensors may include information regarding the objects in the environment, such as the obstacles described herein. Obstacle information may include information regarding the number, density, geometry, and/or spatial disposition of obstacles in the environment.

In some embodiments, sensing results are generated by combining sensor data obtained by multiple sensors, also known as “sensor fusion.” For example, sensor fusion may be used to combine sensing data obtained by different sensor types, including as GPS sensors, inertial sensors, vision sensors, LIDAR, ultrasonic sensors, and so on. As another example, sensor fusion may be used to combine different types of sensing data, such as absolute measurement data (e.g., data provided relative to a global coordinate system such as GPS data) and relative measurement data (e.g., data provided relative to a local coordinate system such as vision sensing data, LIDAR data, or ultrasonic sensing data). Sensor fusion may be used to compensate for limitations or inaccuracies associated with individual sensor types, thereby improving the accuracy and reliability of the final sensing result.

The UAV 100 described herein may be operated completely autonomously (e.g., by a suitable computing system such as an onboard controller), semi-autonomously, or manually (e.g., by a human user). The UAV 100 may receive commands from a suitable entity (e.g., human user or autonomous control system) and respond to such commands by performing one or more actions. For example, the UAV 100 may be controlled to take off from the ground, move within the air (e.g., with up to three degrees of freedom in translation and up to three degrees of freedom in rotation), move to target location or to a sequence of target locations, hover within the air, land on the ground, and so on. As another example, the UAV 100 may be controlled to move at a specified velocity and/or acceleration (e.g., with up to three degrees of freedom in translation and up to three degrees of freedom in rotation) or along a specified movement path. Furthermore, the commands may be used to control one or more UAV 100 components, such as the components described herein (e.g., sensors, actuators, propulsion units, payload, etc.). For example, some commands may be used to control the position, orientation, and/or operation of a UAV 100 payload such as a camera.

The UAV 100 may be configured to operate in accordance with one or more predetermined operating rules. The operating rules may be used to control any suitable aspect of the UAV 100, such as the position (e.g., latitude, longitude, altitude), orientation (e.g., roll, pitch yaw), velocity (e.g., translational and/or angular), and/or acceleration (e.g., translational and/or angular) of the UAV 100. For example, the operating rules may be designed such that the UAV 100 is not permitted to fly beyond a threshold height, e.g., the UAV 100 may be configured to fly at a height of no more than 400 m from the ground. In some embodiments, the operating rules may be adapted to provide automated mechanisms for improving UAV 100 safety and preventing safety incidents. For example, the UAV 100 may be configured to detect a restricted flight region (e.g., an airport) and not fly within a predetermined distance of the restricted flight region, thereby averting potential collisions with aircraft and other obstacles.

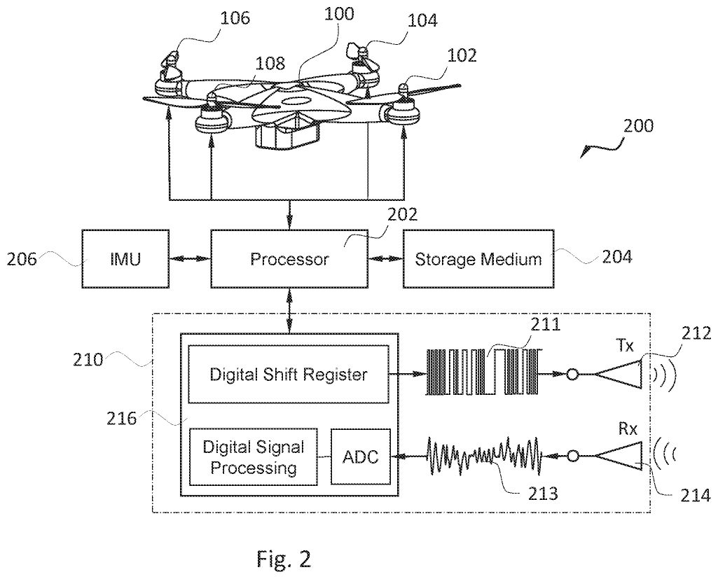

FIG. 2 illustrates an example radar control system 200 in the UAV 100 according to exemplary embodiments of the present disclosure. The radar control system 200 may include a processor 202, a storage medium 204, an inertia measurement unit (IMU) 206, and a radar system 210.

The IMU 206 may be configured to measure any angular velocity (e.g., attitude change) and linear acceleration (e.g., velocity change) of the UAV 100. For example, the IMU 206 may include one or more gyroscopes to measure attitude change (e.g., absolute or relative pitch, roll, and/or yaw angle) of the UAV, and may include one or more accelerometers to measure linear velocity change (e.g., acceleration along x, y, and/or z directions) of the UAV. The gyroscopes and accelerometers may be small enough suitable for the UAV 100. For example, the gyroscopes may be a MEMS gyroscope and the accelerometer may be a MEMS accelerometer. The IMU 206 may be configured to communicate with the processor 202 to send the measured angular and/or linear acceleration data of the UAV 100 to the processor 202. The IMU 206 may also include other relative orientation sensor, which may be any sensor that provides attitude information with respect to a local coordinate system (e.g., the UAV body coordinate) rather than a global coordinate system (e.g., a Newtonian coordinate). Exemplary relative orientation sensors may include vision sensors, LIDAR, ultrasonic sensors, and time-of-flight or depth cameras. The relative orientation sensor data may be analyzed by the processor 202 in order to provide an estimate of a yaw, pitch, and/roll rate and relative yaw, pitch, and/roll angle.

The radar system 210 may be any type of radar available to be implemented in the UAV 100. For example, the radar system 210 may transmit microwave beams (e.g., 1-20 mm wavelength range), laser beams, sonar beams, other type of radar signal beams suitable to detect an object within certain distance from the UAV 100 in a predetermined direction, or any combination thereof. The radar system 210 may include a transmitting antenna (i.e., Tx antenna) 212, a receiving antenna (i.e., Rx antenna) 214, and a signal transmitting/receiving unit (i.e., Tx/Rx unit) 216. The Tx/Rx unit 216 may be a highly-integrated unit, such as a Tx/Rx chip. The Tx/Rx unit 216 may be configured to communicate with the processor 202, generate and transmit radar signal (i.e., Tx signal), and then when the Tx signal is reflected from an object, receive and process the reflected signal (i.e., Rx signal).

For example, the Tx/Rx unit 216 may include a Digital Shift Register to receive instructions from the processor 202 and accordingly generate a series of digital signals 211 for the Tx antenna 212. The Tx antenna 212 may transmit the digital signal 211 as the Tx signal. The Tx antenna 212 may include one or more array antennas. Each array antenna may be arranged with linear arrays, planar arrays, frequency scanning arrays, or any combination thereof. Further, each array antenna may include a plurality of radiating elements, each with a phase shifter. When the processor 202 directs the Tx antenna to excite the radiation elements, each radiation elements may emit its own Tx signal. Since the radiation elements are arranged as an array, construction/destruction interference may occur between the Tx signals emitted from the plurality of radiation elements. Consequently, Tx signal beams may be formed along where the construction interference occurs, and be emitted towards certain direction. The processor 202 may further direct the shifters to shift the phases of Tx signals from each radiation element, thereby manipulate the construction/destruction interference pattern, so as to control the emission and/or transmission direction of the Tx signal beams. According to embodiments of the present disclosure, the processor 202 may control the direction of the Tx signal beam. Further, the processor 202 may control the beam direction in a 2-dimensional manner, i.e., the beam direction may move upward, downward, leftward, and rightward. The radar system 210 may also include a mechanism (e.g., an electronic motor) to rotate the Tx radar along an axial direction of the Tx signal. Accordingly, the Tx signal may be adjusted in a 3-dimensional manner.

Similarly, the Rx antenna may include one or more array antennas. Each array antenna may be arranged with linear arrays, planar arrays, frequency scanning arrays, or any combination thereof. The processor 202 may keep the Rx antenna with a fixed direction or may adjust the Rx antenna based on the direction of the Tx beam. For example, the processor 202 may direct the Rx antenna to receive the Rx signal 213 from predetermined directions. For example, since the Rx signal 213 may or may not be of the same direction of the Tx signal, the processor 202 may adjust the Rx antenna to face towards certain direction to receive the Rx signal 213. Further, the Tx/Rx unit 216 may include one or more analog-to-digital converter (ADC) and one or more Digital Signal Processing units to process the received Rx signal 213. For example, the Digital Signal Processing unit may recognize the object that reflects the Tx signal. The Tx/Rx unit 216 may then send the processed Rx signal to the processor 202.

The processor 202 may communicate with the storage medium 204 to record received data, such as locations of objects detected by the radar system 210. The storage medium may be one or more transitory processor-readable storage media or non-transitory processor-readable storage media, such as flash memory, solid disk, ROM, and RAM, or the like.

The processor 202 may receive the processed Rx signal and determine if the object detected by the radar system 210 is in the UAV's navigation path within a predetermined distance, velocity and heading angle (e.g., range: 10 m, 5 m, 3 m, 2 m, or 1 m; velocity: +2 m/s, −3 m/s, wherein “+” means toward the UAV, “−” means away from the UAV; heading angle: +10° in azimuth, −5° in elevation). If the object is in the navigation path and within the predetermined distance, the processor 202 may determine that the object is an obstacle. In response, the processor 202 may determine a plan to avoid the obstacle. For example, the processor 202 may determine to swiftly turn the UAV 100 towards right to avoid an obstacle 3 meters away. Accordingly, the processor may control respective rotation speeds of the UAV's rotaries to swiftly roll the UAV towards right.

During operation of the UAV 100, when the processor 202 maneuvers the UAV 100, the velocity and/or attitude of the UAV 100 may change. For example, the UAV 100 may swiftly make a right roll to avoid an obstacle. This may have an effect to the directions of both the Tx radar beam and the Rx radar beam. Accordingly, the processor may constantly and/or periodically communicate with the IMU 206, which may measure the UAV's velocity and attitude data, constantly and/or periodically, and adaptively adjust the directions of the Tx/Rx beams of the radar system 210.

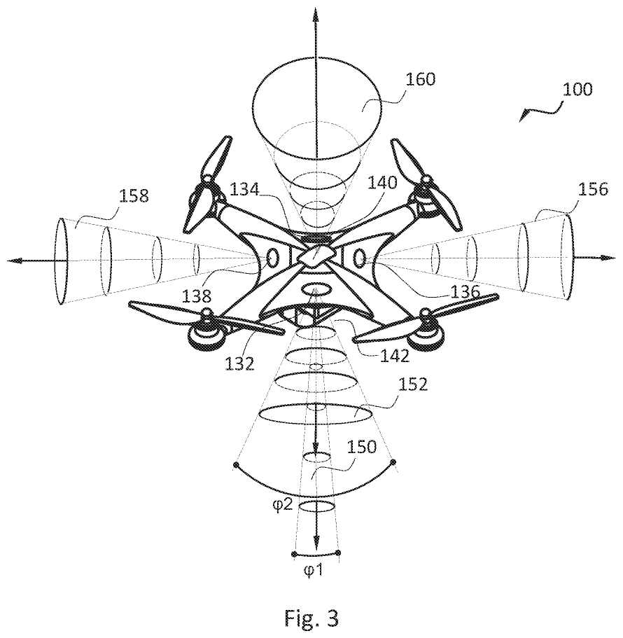

The UAV 100 may include a single-radar system 210 to detect objects appear in a predetermined direction. The UAV 100 may also include a plurality of radars to detect objects in a broader range surrounding the UAV 100. For example, FIG. 3 illustrates the UAV 100 with 6 radars according to some embodiments of the present disclosure, i.e., a front radar 132, a rear radar 134, a left radar 136, a right radar 138, a top radar 140, and a bottom radar 142. According to other embodiments, the UAV 100 may include more or less than the above mentioned 6 radars.

Each of the radars 132, 134, 136, 138 may transmit at least a beam of radar signal towards a predetermined direction. For example, the left radar 136 may transmit radar a beam 156 towards the left side of the UAV 100 with respect to the front side, the right radar 138 may transmit a radar beam 158 towards the right side of the UAV 100 with respect to the front side, and the top radar 140 may transmit a radar beam 160 upward. The radar beams transmitted from the radars 132, 134, 136, 138, 140, 142 may be microwave beam, laser beam, sonar beam, other type of radar signal beam suitable to detect an object within certain distance from the UAV 100 in the predetermined direction, or any combination thereof.

Some or all of the radars 132, 134, 136, 138, 140, 142 may transmit more than one radar beams. Each of the radar may transmit radar beams with frequencies the same or different from other radars; and the radar beams transmitted by the same radar may be of the same or different frequencies. For example, as shown in FIG. 3, the front radar 132 may have operate under different modes, such as a long beam mode and a short beam mode to transmit two different beams of radar signal. Under the long beam mode, the front radar 132 may transmit a long beam 150; and under the short beam mode, the front radar 132 may transmit a short beam 152. The processor 202 may control and/or adjust parameters of the Tx/Rx unit 216 of the front radar 132 to switch the front radar 132 between the long beam mode and the short beam mode, i.e., the processor 202 may control the front radar 132 to transmit the long beam 150 only, transmit the short beam 152 only, or transmit the long beam 150 and short beam 152 alternatively under predetermined frequencies.

The two beams 150, 152 may be microwave beam, laser beam, sonar beam, other type of radar signal beam suitable to detect an object within certain distance from the UAV 100 in the predetermined direction, or any combination thereof. For example, the first beam 150 may be a microwave beam with a first beam width φ1 between 10°-20°; and the short beam 152 may be a microwave beam with a second beam width φ2 between 50°-70°. The long beam 150 may have an effective detection range over 70 meters and may reach up to 100 meters; and the short beam may have an effective detection range around 50 meters. Consequently, the UAV 100 may use the short beam to detect objects closer to the UAV and use the long beam to detect objects farther away from the UAV. The radar 132 may transmit the short beam 152 at a first frequency, and transmit the long beam 150 at a second frequency. For example, both the long beam and short beam may be 20 mm microwave beam; and the radar 132 may emit the short beam at a frequency of 50 Hz (e.g., detecting objects within 50 meters of the UAV 50 times per second) and emit the long beam at a frequency of 20 Hz (e.g., detecting objects between 50-70 meters of the UAV 20 times per second). Since the short beam 152 may detect objects closer to the UAV, the UAV may transmit the short beam 152 in a higher frequency, i.e., the first frequency is higher than the second frequency.

Each of the radars 132, 134, 136, 138, 140, 142 may adjust the direction of the radar beam in a multiple-dimensional way (e.g., along two dimensions). For example, the front radar 132 may adjust direction of the radar beam 152 not only upward and downward but also towards left side and towards right side of the UAV 100. Accordingly, the radar 132 may adjust the radar beam 152 towards any direction within a cone-shaped space. According to exemplary embodiments of the present disclosure, the aperture of the cone-shaped space may be up to 180°. Similarly, the radar 132, 134, 136, 138, 140, 142 may be able to adjust the directions of the short beam and long beam separately and independently, and in the 2-dimensional manner described above.

Accordingly, the radars 132, 134, 136, 138, 140, 142 may substantially maintain their respective radar beams to the respective predetermined directions even if the UAV 100 is in linear or angular motion.

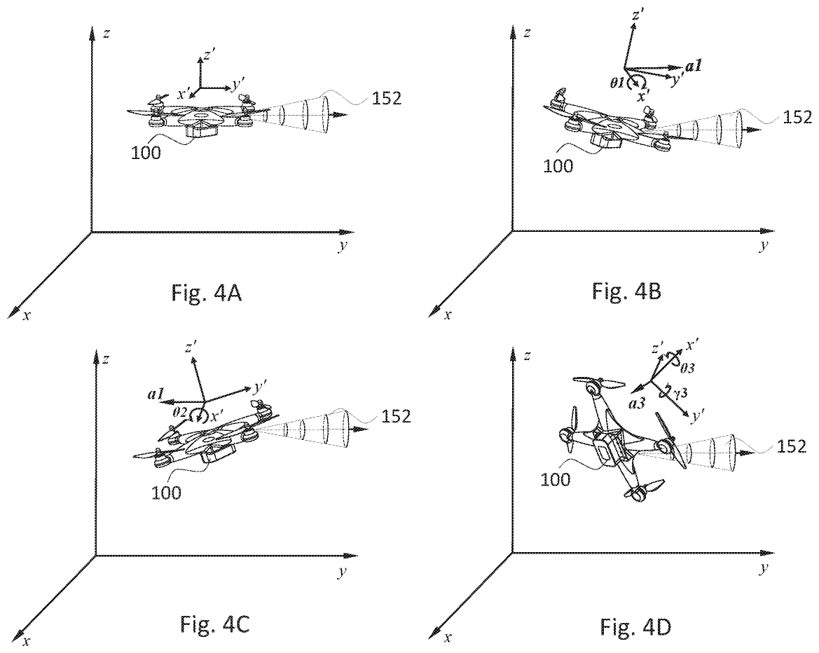

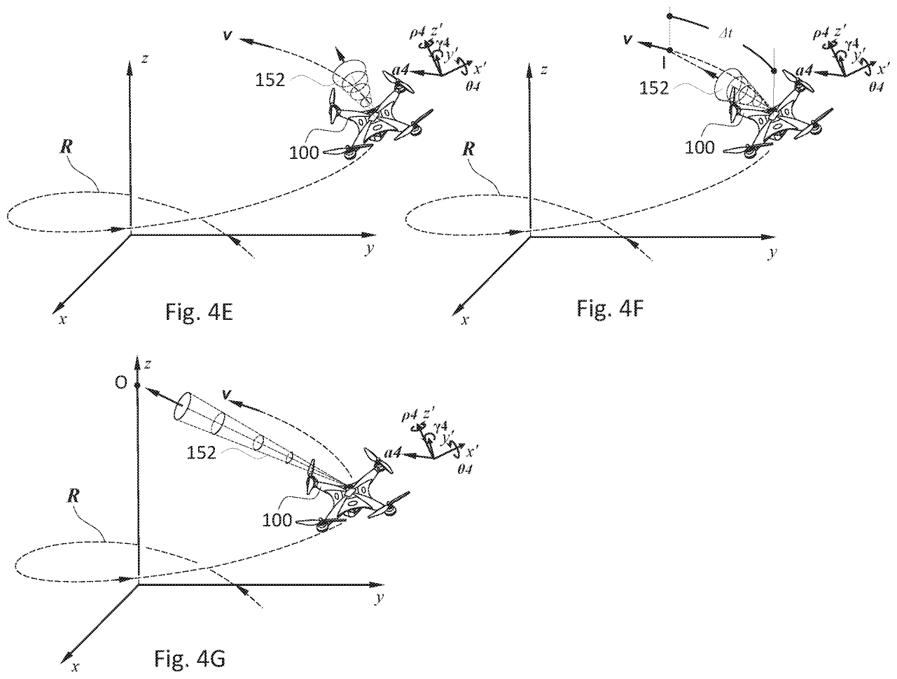

FIGS. 4A-4G illustrate an UAV 100 that transmits a radar beam towards predetermined directions under different flight attitudes, according to embodiments of the present disclosure. The x-y-z coordinates are an inertial reference frame. The x′-y′-z′ coordinates are a local reference wherein the y′ axis is always pointing towards the front side of the UAV 100 and the z′ axis is always pointing towards the upside of the UAV 100. Merely for illustration purpose, the radar beam that the UAV 100 transmits is selected as the front radar beam 152. One of ordinary skill in the art would understand that the UAV 100 may also transmits radar beams other than the front radar beam 152 and towards other predetermined directions.

FIG. 4A-4D illustrate a scenario where the UAV 100 is required to transmit a radar beam horizontally along y-axis direction in the x-y-z inertial reference frame under different attitudes. For example, when the UAV 100 is navigating near the ground, the UAV 100 may do so avoid the radar beam being reflected from ground. In FIG. 4A, the UAV 100 transmits the radar beam 152 horizontally along y-axis direction in the x-y-z inertial reference frame while hovering in the air. In FIG. 4B, when the UAV 100 accelerates forward with an acceleration α1 along the y-axis, it may pitch forward with an angle θ1. Accordingly, the UAV 100 may adaptively adjust the direction of the radar beam 152 upward with the angle θ1 with respect to the UAV 100 so that the radar beam 152 remain being transmitted towards the y-axis in the x-y-z Inertial reference frame. In FIG. 4C, when the UAV 100 deaccelerates with an acceleration α2 along the y-axis, it may pitch backward with an angle θ2. Accordingly, the UAV 100 may adaptively adjust the direction of the radar beam 152 downward with the angle θ2 with respect to the UAV 100 so that under the radar beam 152 remain being transmitted towards the y-axis in the x-y-z Inertial reference frame. Further, in FIG. 4D, when the UAV 100 maneuvers to avoid an obstacle, it may accelerate towards a front left direction α3. Accordingly, it may pitch forward with an angle θ3 and roll towards left with an angle γ3 at the same time. Accordingly, the UAV 100 may adaptively adjust the direction of the radar beam 152 upward and rightward with respect to the UAV 100 so that under the radar beam 152 remain being transmitted towards the y-axis in the x-y-z Inertial reference frame.

In addition to a fixed direction, the UAV 100 may direct the radar beam to any preferred direction as needed under an attitude. For example, in FIG. 4E the UAV 100 may adaptively adjust the radar beam 152 along its movement direction (i.e., direction of its velocity). When the UAV 100 maneuvers along the complicated navigation path R, its attitude may be a combination of pitch θ4, roll γ4, and yaw ρ4. The UAV 100 may determine a direction of its velocity v in the inertial reference frame x-y-z (e.g., via an internal GPS system and/or the IMU 206) and adaptively direct the radar beam 152 along the direction of the velocity v. For example, the UAV 100 may determine the local reference (i.e., a relative reference coordinate system) x′-y′-z′, and the origin of the coordinate locates in a fixed point of the UAV 100. The UAV 100 may then determine an angle between the y′ axis and the direction of velocity v, and adaptively adjust the direction of the radar beam 152 along this angle such that the adjusted direction of the radar beam 152 is substantially aligned with the direction of velocity v.

In FIG. 4F, the UAV 100 may adaptively adjust the radar beam 152 to point towards a point/where the UAV 100 will arrive in a predetermined period of time Δt. The UAV 100 may select the predetermined period of time Δt based on a minimum reaction time (e.g., data processing speed) of the UAV 100. For example, if the UAV 100 needs at least 2 seconds to maneuver around an obstacle, then the predetermined period of time Δt may be a time equal to or longer than 2 seconds. Accordingly, if there is an obstacle on the UAV's navigation path, because the UAV 100 may detect the obstacle no less than 2 seconds before it collides into the obstacle, the UAV 100 may have sufficient time to avoid the obstacle. Depending on the minimum reaction speed of the UAV 100, the predetermined period of time Δt may be 1 second, 2 second, 5 seconds, etc. or any other suitable period of time. The UAV 100 may determine and/or estimate the navigation path R in real time or nearly real time based on its velocity, and determine and/or estimate the position/with respect to the local reference coordinate system x′-y′-z′. The UAV 100 then may adaptively and dynamically adjust the direction of the radar beam 152 towards the position of point I with respect to the reference coordinate system x′-y′-z′.

In FIG. 4G, the UAV may adaptively adjust the radar beam 152 towards a predetermined point O, where point O is a stationary object or a moving object. For example, during navigation the UAV 100 may track another object, moving or stationary, represented by point O in FIG. 4G. The UAV 100 may determine a relative position and relative velocity of the point O in real time or nearly real time with respect to the reference coordinate system x′-y′-z′, and then adaptively and dynamically adjust the direction of the radar beam 152 towards the relative position of point O.

According to embodiments of the present disclosure, prior to arriving point I, the UAV 100 may predict the position and orientation of the UAV 100 at point I, and adjust the radar beam in advance, so that the radar beam stays aligned with the y′ axis (as in FIG. 4E), or stays pointed at a given object (as in FIG. 4G).

As shown above, depending on the attitude, the UAV 100 may pitch, row, and yaw in a 3-dimensional manner and at different angles. Accordingly, the radars of the UAV 100 may adaptively adjust the radar beam direction in a 2-dimensional manner (e.g., along two orthogonal axes) in order to transmit the radar beam to a predetermined direction. The change of attitude may further induce angular motion of the radar beam along an axis of the transmission direction. Accordingly, the UAV may further adjust the radar beam in a 3-dimensional manner to offset the angular motion.

In some embodiments, the movement (e.g., the maneuver movement to avoid the obstacle and/or the direction of the radar beams) of the UAV 100 may be automatic. For example, the UAV may navigate along a predetermined navigation route. The processor 202 may control the radar beam to be transmitted to a fixed direction, to a fixed object in the air or on the ground, or a moving object in the air or on the ground. The terminal may also control the radar beam to be transmitted to a point where the UAV will arrive in a predetermined time period.

The UAV may also be controlled by a terminal (not shown). The terminal may be a remote control device at a location distant from the UAV. The terminal may be disposed on or affixed to a support platform. Alternatively, the terminal may be a handheld or wearable device. For example, the terminal may include a smartphone, tablet, laptop, computer, glasses, gloves, helmet, microphone, or suitable combinations thereof. The terminal may include a user interface, such as a keyboard, mouse, joystick, touchscreen, or display. Any suitable user input may be used to interact with the terminal, such as manually entered commands, voice control, gesture control, or position control (e.g., via a movement, location or tilt of the terminal).

The terminal may be used to control any suitable state of the UAV 100. For example, the terminal may be used to control the position and/or orientation of the UAV 100 relative to a fixed reference from and/or to each other. In some embodiments, the terminal may be used to control individual elements of the UAV 100, such as the direction of the radar beam. For example, the terminal may control the radar beam to be transmitted to a fixed direction, to a fixed object in the air or on the ground, or a moving object in the air or on the ground. The terminal may also control the radar beam to be transmitted to a point where the UAV 100 will arrive in a next moment. The terminal may include a wireless communication device adapted to communicate with the radar system 210, directly or through the processor 210.

The terminal may include a suitable display unit for viewing information of the UAV 100. For example, the terminal may be configured to display information of the UAV 100 with respect to position, translational velocity, translational acceleration, orientation, angular velocity, angular acceleration, or any suitable combinations thereof. In some embodiments, the terminal may display information provided by the payload, such as data provided by a functional payload (e.g., images recorded by a camera or other image capturing device).

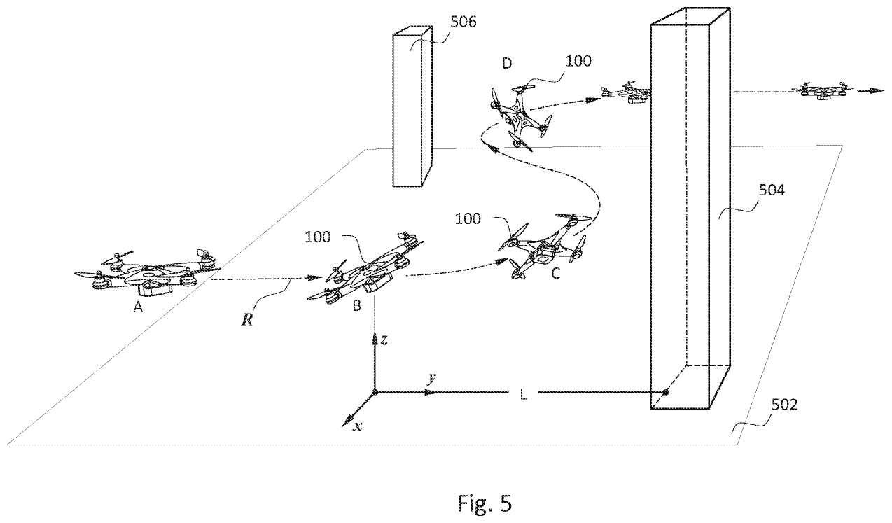

FIG. 5 illustrates a UAV 100 that maneuvers through an environment with obstacles, according to embodiments of the present disclosure. The environment 500 may be an outdoor environment, indoor environment, or a combination thereof.

In some embodiments, the environment 500 may include one or more obstacles 504, 506. An obstacle may include any object or entity that may obstruct the movement of the UAV 100. Some obstacles may be situated on the ground 502, such as buildings, walls, roofs, bridges, construction structures, ground vehicles (e.g., cars, motorcycles, trucks, bicycles), human beings, animals, plants (e.g., trees, bushes), and other manmade or natural structures. Some obstacles may be in contact with and/or supported by the ground 502, water, manmade structures, or natural structures. Alternatively, some obstacles may be wholly located in the air, such as aerial vehicles (e.g., airplanes, helicopters, hot air balloons, other UAVs) or birds. Aerial obstacles may not be supported by the ground 502, or by water, or by any natural or manmade structures. An obstacle located on the ground 502 may include portions that extend substantially into the air (e.g., tall structures such as towers, skyscrapers, lamp posts, radio towers, power lines, trees, etc.). The obstacles described herein may be substantially stationary (e.g., buildings, plants, structures) or substantially mobile (e.g., human beings, animals, vehicles, or other objects capable of movement). Some obstacles may include a combination of stationary and mobile components (e.g., a windmill). Mobile obstacles or obstacle components may move according to a predetermined or predictable path or pattern. For example, the movement of a car may be relatively predictable (e.g., according to the shape of the road). Alternatively, some mobile obstacles or obstacle components may move along random or otherwise unpredictable trajectories. For example, a living being such as an animal may move in a relatively unpredictable manner.

To navigate through the environment with obstacles 504, 506, the UAV 100 may turn on one or more of its radars to detect its surrounding obstacles. In some embodiments, the UAV 100 may turn on the front radar 132 to transmit at least one Tx radar beam along the navigation path R to detect and avoid the obstacles 504, 506. For example, when the UAV 100 is at point A, it may navigate at a constant velocity along a straight and horizontal y direction, and therefore transmitting the Tx radar beam along y direction, as shown in FIG. 4A. The UAV 100 may use the short beam 152 to detect objects closer to the UAV 100 and use the long beam 150 to detect objects father away from the UAV 100. Both the long beam and the short beam may respectively have an effective range for detecting objects appear therein.

Additionally, the UAV 100 may also turn on any other radars to detect surrounding objects. For example, the UAV may turn on the rear radar 134 to detect any stationary or moving object on the ground or in the air that is behind it. The UAV 100 may turn on the left radar 136 to detect any stationary or moving object on the ground or in the air on the left side of it. The UAV 100 may turn on the right radar 138 to detect any stationary or moving object on the ground or in the air on the right side of it. The UAV 100 may turn on the top radar 140 to detect any stationary or moving object in the air above it. The UAV 100 may also turn on the bottom radar 142 to detect any stationary or moving object below it. These radars are configured to detect, in real time or nearly real time, information such as positions, velocities, size of objects within their respective effective range. Further, the UAV 100 may adjust the radar to transmit Tx beams to any predetermined direction. For example, the processor 202 may direct the radars 132, 134, 136, 138, 140, 142 to periodically scan at their largest aperture so as to cover the entire spherical space surrounding the UAV 100.

The processor 202 may store the information of the surrounding objects. Storing the information may be in real time, nearly real time, or in a later time. The UAV 100 may store the information in the local storage medium 204, or may wirelessly transmit the information to a remote non-transitory storage medium.

The UAV100 may also monitoring its navigating status (velocity, acceleration, attitude etc.) and store the navigation status to the storage medium in real time or nearly real time while navigating. The UAV 100 may use the GPS system embedded therein to receive its own position, orientation, and speed information with respect to the x-y-z reference coordinate and/or the x′-y′-z′ reference coordinate (as shown in FIGS. 4A-4G). The UAV 100 may also determine its velocity information via real time receiving linear acceleration data and attitude data (e.g., via measuring angular velocities of the UAV 100) of the UAV 100 from the IMU 206. At point A, for example, the UAV 100 is at a constant velocity, thus the IMU 206 may detect zero acceleration for both velocity change and attitude change; at point B, however, the UAV 100 is reducing its speed, therefore the IMU 206 may detect a non-zero pitch angle and a non-zero deceleration value.

When the UAV 100 navigates to position B, the obstacle 504 may come into the effective detection range of the radar beam. The obstacle 504 may reflect the Tx beam, and the Rx antenna 214 may subsequently receive the reflected Rx beam. Based on the received Rx beam, the processor 202 of the UAV 100 may then determine its distance from the obstacle 504 and how fast it is moving towards the obstacle 504. Next, based on the UAV's velocity, the processor 202 may determine the time interval that the UAV 100 will collide into the obstacle 504. And based on the time interval, the processor 202 may determine how swift and/or abrupt and/or smooth it must maneuver the UAV 100 to avoid the obstacle 504. After this, the processor 202 may operate a propulsion mechanism of the UAV 100 to so maneuver. For example, the processor 202 may direct the rotary wings of the UAV 100 to respectively change their rotation speed to adjust the navigation attitude. For example, if the obstacle is still far away from the UAV 100, or the navigation speed is low enough, so that the UAV 100 still have enough time to smoothly maneuver around the obstacle 504 (e.g., the UAV would need 5 seconds to collide into the obstacle 504), the processor 202 may smoothly adjust the UAV 100 to avoid the obstacle 504. However, if the obstacle 504 is too close, or the navigation speed to too fast, so that the UAV 100 have limited time to react (e.g., the UAV 100 is 1 second away from colliding into the obstacle 504), then the processor 202 may sharply maneuver the UAV 100 to avoid the obstacle 504. As shown in FIG. 5, in point B, the processor 202 adjusts the UAV to pitch backward to decelerate. To this end, the processor 202 may decelerate the UAV 100 by lowering the power (e.g., lowering rotation speed) of the two rear rotary wings and increasing the power (e.g., increasing rotation speed) of the two front rotary wings.

Since the head of the UAV 100 raises up due to deceleration, the processor 202 may adaptively adjust the radar to keep transmitting the radar beam horizontally towards the obstacle 504. To this end, the processor 202 may receive the signal detected and sent from the IMU 206 and determine the current attitude of the UAV 100. The processor 202 may sample the signals from the IMU 206 with a constant sampling frequency. Alternatively, the processor 202 may vary the sampling frequency to the signals from the IMU 206 when detecting the attitude of the UAV 100. For example, the processor 202 may raise the sampling frequency when the UAV 100 needs to detect tiny change of the attitude of UAV 100; and the processor may lower the sampling frequency when the need to detect tiny change of attitude of the UAV 100 is low. In another example, the processor 202 may adopt a lower frequency to sample signals from the IMU 206 when the UAV 100 is navigating smoothly, and may raise the sampling frequency from the IMU 206 when adjusting the attitude of the UAV abruptly. The faster the processor 202 adjusts the attitude, the higher frequency it may sample the signal from the IMU 206.

With the real-time sampling of the attitude signal from the IMU 206, the processor 202 may determine the pitch angle of the UAV 100 in real time or nearly real time, and then dynamically and adaptively adjust the angle of the radar beam downward to keep the Tx radar beam horizontally forward along x-direction, as shown in FIG. 4C.

The processor 202 may also determine to roll or yaw the UAV to avoid the obstacle 504. For example, at point C, processor 202 rolls the UAV 100 towards left by lowering the power (e.g., lowering rotation speed) of the two left rotary wings and increasing the power (e.g., increasing rotation speed) of the two right rotary wings. The yaw or combination of pitch and yaw may cause the navigation path R to deviate from the original straight line along the x-direction, and the Tx radar signal may also deviate from the original direction. Accordingly, the processor 202 may adaptively adjust the radar to substantially correct the deviation and keep transmitting the Tx radar beam towards a predetermined direction (e.g., the original direction).

For example, the predetermined direction may be a velocity direction of the UAV 100, i.e., the predetermined direction may be a tangible direction of the path R that the UAV 100 navigates. To this end, the processor 202 may receive the signal from the IMU 206 and determine the current attitude and/or acceleration of the UAV 100. With the real time sampling of the attitude signal from the IMU 206, the processor 202 may determine the velocity of the UAV 100 as well as the attitude (i.e., pitching angle, rolling angle, and yawing angle) with respect to the direction of the velocity in real time or nearly real time. And then the processor 202 may dynamically and adaptively adjust the angle or angles of the Tx radar beam to turn the Tx radar beam towards the direction of the velocity, as shown in FIG. 4E. Similarly, the processor 202 may also direct the Tx radar beam towards a fix direction, such as the horizontal x-direction as shown in FIG. 4D.

While navigating, the UAV 100 may also turn on other radars 134, 136, 138, 140, 142 to detect and record surrounding objects along the navigation path R, or direct one or more of its radars 132, 134, 136, 138, 140, 142 to a predetermined direction, such as shown in FIGS. 4A-4D, or a stationary or moving object in the Inertial reference frame x-y-z, as shown in FIG. 4G.

Accordingly, the UAV 100 may be able to detecting one or more obstacles appear in its navigation path R in real time or nearly real time, and then maneuver to avoid the detected one or more obstacles. For example, after turning left to avoid the obstacle 504 at point C, the UAV 100 may detect that the obstacle 506 subsequently appears ahead in its navigation path R. In response, the UAV 100 may continue to maneuver around obstacle 506 around at point D to further avoid the obstacle 506.

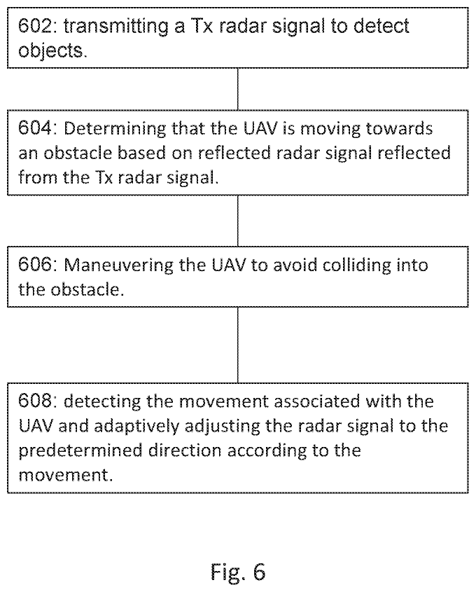

FIG. 6 illustrates a method for an unmanned movable platform to detect and avoid an obstacle during navigation, according to the embodiments as shown in FIGS. 1-5G. The method may be implemented in an unmanned movable platform, such as the UAV 100, an unmanned surface water ship, an unmanned submarine, an unmanned ground vehicle, an unmanned hovercraft, or a combination thereof. For illustration purpose, the UAV 100 is used as an example unmanned movable platform in the method.

The UAV 100 may include at least one radar, at least one sensor such as the IMU 206, at least one non-transitory and/or transitory storage medium, and at least one processor. The at least one radar may be configured to detect an object by sending out Tx radar signal and receiving reflected Rx radar signal from the object. The at least one sensor, such as the IMU 206, may be configured to detect accelerations associated with the UAV 100. For example, the IMU 206 may detect a linear acceleration or an attitude change of the UAV 100. The method may be implemented as a set of instruction stored in the storage medium (e.g., EPROM, EEPROM, ROM, RAM etc.). The processor 202 may access to the storage medium, and when executing the set of instructions, may be directed to conduct the following process and/or steps.

602: Transmitting Tx radar signal to detect objects.

For example, when the UAV is under ordinary navigation, its front radar may transmit a radar beam to the front direction along the navigation path to detect any object appears in its effective range, as shown in point A in FIG. 5.

To this end, the radar may periodically transmit a first radar beam at a first frequency and periodically transmit a second radar beam at a second frequency lower than the first frequency. The first radar beam may be the short beam, as introduced above, to scan through a wider range of area. The second radar beam may be the long beam, as introduced above, to detect objects farther away.

Further, since the UAV 100 may include multiple radars, it may turn on other radars to detect information of surrounding objects surrounding the UAV while navigation in real time or nearly real time. The information of the surrounding objects may include positions, shape, velocity of these objects etc. The UAV 100 then may save the information in a local storage medium and/or a remote storage medium in real time, nearly real time, or in a later time.

604: Determining that the UAV is moving towards an obstacle based on reflected radar signal (e.g., the Rx radar signal) reflected from the Tx radar signal.

For example, the UAV 100 may receive the Rx radar signal when the obstacle 504 in FIG. 5 appears in the effective range of the radar. The UAV 100 may determine the position of the obstacle 504, its distance from the obstacle 504, and the speed that the obstacle 504 is moving towards the UAV 100 based on its current navigation path and/or trajectory.

606: Maneuvering the UAV to avoid colliding into the obstacle.

For example, based on the distance of the obstacle 504 and the relative speed between the UAV 100 and the obstacle 504, the UAV 100 may determine a target navigation status to adjust in order to avoid the obstacle 504. For example, the UAV 100 may determine a target attitude, a target movement and/or a target acceleration (i.e., how smooth and/or swift it may need) to avoid the obstacle 504. The target attitude may include a target roll angle (i.e., accelerating towards one side), a target pitch angle (i.e., liner acceleration), a target yaw angle (i.e., the UAV turning towards certain direction), or a combination thereof to which the UAV 100 may adjust in a next moment of its navigation. And then, the UAV 100 may adjust its attitude to the target attitude to achieve the needed movement to avoid the object. Practically, the UAV's attitude adjustment may be disturbed by various factors such as wind. Accordingly, the UAV 100 may use the IMU to provide real time feedback of its attitude status to ensure accurate adjustment. For example, the accelerometer of the IMU may measure the UAV's linear accelerations in real time or nearly real time along the x′, y′, z′ axis and feedback the measured data to the processor of the UAV 100. Similarly, the gyroscope of the IMU may measure angle and/or angular velocity (roll, yaw, pitch) of the UAV 100 in real time or nearly real time and feedback the measured data to the processor of the UAV 100. Accordingly, the UAV 100 may determine its movement and/or acceleration, etc. in real time or nearly real time by doing integration to the feedback data from the IMU, and use the feedback to make sure it achieves the needed attitude (e.g., movement, velocity, acceleration, etc.).

608: detecting the movement associated with the UAV and adaptively adjusting the radar signal to the predetermined direction according to the movement.

The movement may be measured by a sensor on the UAV 100, such as a GPS system, an IMU, a vision sensor etc. For example, the IMU 206 may measure an actual navigation status (e.g., movement, attitude, and/or acceleration) of the UAV 100 and send measured data to the processor 202 of the UAV 100. Based on the measured data, and during the course of the adjustment, the UAV 100 may determine a direction to transmit the Tx radar signal in real time or nearly real time. For example, to transmit the Tx radar signal along the direction of the velocity of the UAV 100, as shown in FIG. 4E, the UAV 100 may use its acceleration to determine its actual velocity and actual attitude, and accordingly adjust the direction of the Tx radar signal with respect to the reference coordinate x′-y′-z′ in real time or nearly real time. Alternatively, the UAV 100 may transmit the Tx radar signal to a point where the UAV 100 will arrive in a predetermined time, as shown in FIG. 4F. Because the Tx radar signal may have an width (or divergence angle), thereby covers a certain width of area other than just a straight line, both arrangement may be able to detect other obstacles that might appear on a path that the UAV 100 will pass through in the predetermined time.

In addition, the UAV 100 may also use other radars to transmit radar signals to constantly point to a fixed object or a moving object, and/or a predetermined fixed direction, as shown in FIGS. 4A-4E.

As long as the UAV 100 keeps maneuvering, the UAV 100 may detecting the acceleration value associated with the linear speed and attitude of the UAV 100 in real time or nearly real time and adaptively adjust the Tx radar signal so that the Tx radar signal substantially remain the predetermined direction. Additionally, the UAV 100 may also adoptively adjust the orientation of the Rx antenna corresponding to the change in the Tx radar beam to maximize receipt of the Rx radar signal. As introduced above, the change of attitude may include two or more of linear acceleration αlong x, y, and/or z directions, and/or include pitch, roll, and/or yaw motions. Accordingly, the adjustment may be 2-dimensional manner, as shown in FIGS. 4A-4G and FIG. 5.

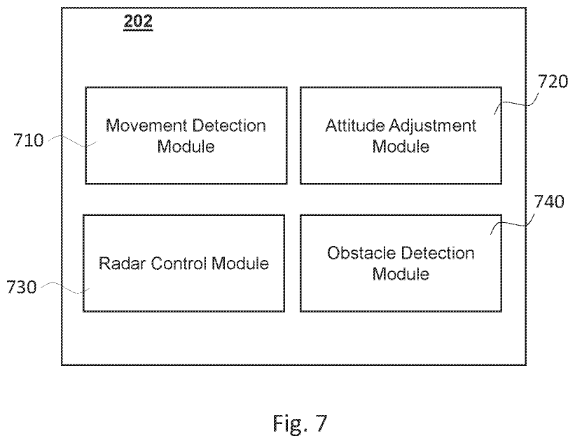

FIG. 7 is a block diagram of the processor 202 of the UAV 100 according to embodiments of the present disclosure. The processor 202 may include a movement detection module 710, an attitude adjustment module 720, a radar control module 730, and an obstacle detection module 740. The modules of the processor 202 may be configured to execute the method introduced in FIG. 6.

According to embodiments of the present disclosure, the radar control module 730 may be configured to control the radar of the UAV 100 transmit the radar beam to any predetermined direction.

For example, when the UAV 100 is under ordinary navigation, the radar control module may control the front radar to transmit a radar beam to the front direction along the navigation path to detect any object appears in its effective range, as shown in point A in FIG. 5.

To this end, the radar control module 730 may control the radar to periodically transmit the first radar beam at the first frequency and periodically transmit the second radar beam at the second frequency lower than the first frequency.

Since the UAV 100 may include multiple radars, the radar control module 730 may also turn on other radars to detect information of surrounding objects surrounding the UAV while navigation in real time or nearly real time. The information of the surrounding objects may include positions, shape, velocity of these objects etc. The UAV 100 then may save the information in a local storage medium and/or a remote storage medium in real time, nearly real time, or in a later time.

The obstacle detection module 740 may be configured to detect an obstacle appear in the effective range of the UAV's radar. The movement detection module 710 may be configured to detect movement of the UAV 100 and movement of an object detected by the radar control module. According to embodiments of the present disclosure, the obstacle detection module 740 may detect the obstacle 504 on the UAV 100 navigation path, and then the movement detection module 710 may determine that the UAV 100 is moving towards an obstacle based on the Rx radar signal. The movement detection module 710 then may determine the distance of the obstacle and the speed that the UAV 100 is moving towards the obstacle.

The attitude adjustment module 720 may be configured to maneuvering the UAV to reach the acceleration to avoid colliding into the obstacle. For example, based on the distance and speed information from the movement detection module 710, the attitude adjustment module 720 may determine an attitude and how smooth and/or swift it may need to adjust to the attitude in order to obtain the necessary acceleration to avoid the obstacle 504. And then the attitude adjustment module 720 may adjust its attitude to achieve the needed acceleration.

The radar control module 730 may transmit Tx radar signal towards a predetermined direction according to the acceleration. The movement detection module 710 may measure the acceleration and send the acceleration value to the radar control module 730. Based on the acceleration value the radar control module 730 may determine a direction to transmit the Tx radar signal. For example the radar control module 730 may transmit the Tx radar signal along the direction of the velocity of the UAV 100, as shown in FIG. 4E. Alternatively, the radar control module 730 may transmit the Tx radar signal to a point where the UAV 100 will arrive in a predetermined time, as shown in FIG. 4F.

In addition, the radar control module 730 may also turn on other radars of the UAV 100 to transmit radar signals to constantly point to a fixed object or a moving object, and/or a predetermined fixed direction, as shown in FIGS. 4A-4E.

The movement detection module 710 may keep real time detecting the acceleration associated with the UAV and the radar control module 730 may adaptively adjust the radar signal to maintain the predetermined direction according to the acceleration.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. For example, the steps in the methods of the present disclosure may not necessarily be operated altogether under the described order. The steps may also be partially operated, and/or operated under other combinations reasonably expected by one of ordinary skill in the art. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

What is claimed is:

1. An unmanned movable platform (UMP), comprising:
at least one sensor configured to detect a movement associated with the UMP;
at least one radar configured to transmit a radar signal; and
at least one processor configured to:
receive a sensor signal associated with the movement from the at least one sensor; and
direct the at least one radar to adjust a direction of a beam of the radar signal based at least in part on the sensor signal.

2. The UMP of claim 1, wherein the direction of the beam of the radar signal is adjusted along at least two orthogonal axes.

3. The UMP of claim 1, wherein:
the at least one radar is further configured to detect an object that reflects the radar signal; and
the at least one processor is further configured to:
determine that the UMP is moving towards the object based on a reflected radar signal reflected by the object; and
maneuver the UMP to avoid colliding into the object.

4. The UMP of claim 3, further comprising a propulsion system having a plurality of propellers;
wherein the at least one processor is further configured to direct the propulsion system to drive the plurality of propellers to change an attitude of the UMP to a predetermined attitude to avoid colliding into the object.

5. The UMP of claim 4, wherein the propulsion system further includes:
a plurality of rotors connected to the plurality of propellers; and
an Electronic Speed Control connected to the at least one processor and configured to control rotation speed of the plurality of rotors.

6. The UMP of claim 1, wherein:
the movement associated with the UMP causes the direction of the beam of the radar signal to deviate from a predetermined direction, and
the direction of the beam of the radar signal is adjusted to substantially correct the deviation.

7. The UMP of claim 6, wherein the predetermined direction is a horizontal direction.

8. The UMP of claim 6, wherein the predetermined direction is a moving direction of the UMP.

9. The UMP of claim 6, wherein the predetermined direction points to a fixed object or a moving object.

10. The UMP of claim 6, wherein the predetermined direction points to a position that the UMP will arrive after a predetermined time.

11. The UMP of claim 6, wherein the deviation is determined based at least in part on the sensor signal.

12. The UMP of claim 1, wherein the at least one processor is configured to direct the at least one radar to adjust the direction of the beam of the radar signal to constantly point to a predetermined fixed direction.

13. The UMP of claim 1, wherein the radar signal is a microwave having a wavelength between 1 mm and 20 mm.

14. The UMP of claim 1, wherein the at least one radar comprises at least one of:
a radar in a front side of the UMP;
a radar in a rear side of the UMP;
a radar in a left side of the UMP;
a radar in a right side of the UMP;
a radar in a top side of the UMP; or
a radar in a bottom side of the UMP.

15. The UMP of claim 1, further comprising at least one storage medium,
wherein the at least one radar is configured to detect positions of a plurality of surrounding objects surrounding the UMP in real time, and
wherein the at least one processor is further configured to store the positions to the at least one storage medium in real time.

16. The UMP of claim 1, wherein the at least one radar is configured to transmit:
a first radar beam having a first detection range and a first beam width; and
a second radar beam having a second detection range longer than the first detection range and a second beam width narrower than the first beam width.

17. The UMP of claim 16, wherein the at least one radar is configured to:
periodically transmit the first radar beam at a first frequency; and
periodically transmit the second radar beam at a second frequency lower than the first frequency.

18. A method for adjusting radar signal direction on an unmanned movable platform (UMP) during navigation, comprising:
transmitting a radar signal;
detecting a movement associated with the UMP; and
adjusting a direction of a beam of the radar signal according to the movement.

19. The method of claim 18, wherein the radar signal is adjusted along at least two orthogonal axes.

20. The method of claim 18, wherein:
the movement associated with the UMP causes the direction of the beam of the radar signal to deviate from a predetermined direction, and
the direction of the beam of the radar signal is adjusted to substantially correct the deviation.
